(19) United States
(12) Patent Application Publication
(10) Pub. No.: US 2025/0088959 A1
(43) Pub. Date: Mar. 13, 2025

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhe FU, Dongguan (CN); Yi HU, Dongguan (CN)

(21) Appl. No.: 18/955,927

(22) Filed: Nov. 21, 2024

Related U.S. Application Data
(63) Continuation of application No. PCT/CN2022/097973, filed on Jun. 9, 2022.

(51) Int. Cl. H04W 52/02; H04W 74/0833

(52) U.S. Cl. CPC H04W 52/0209; H04W 74/0833

(57) ABSTRACT

A communication method, a terminal device, and a network device are provided. The method includes: performing, by a terminal device, communication based on a network state or network state-related information; or the method includes: performing, by a network device, communication based on the network state or the network state-related information.

### CROSS-REFERENCE TO RELATED APPLICATIONS

This application is a continuation of International Application No. PCT/CN2022/097973, filed on Jun. 9, 2022, the disclosure of which is hereby incorporated by reference in its entirety.

### TECHNICAL FIELD

This application relates to the field of communications technologies, and more specifically, to a communication method, a terminal device, and a network device.

### BACKGROUND

With development of communications technologies, energy consumption of a communications network is increasing and has become an important part of operating costs of an operator. Therefore, how to reduce the energy consumption of the communications network becomes a technical problem that needs to be urgently resolved.

### SUMMARY

Embodiments of this application provide a communication method, a terminal device, and a network device. Various aspects of embodiments of this application are described below.

According to a first aspect, a communication method is provided, including: performing, by a terminal device, communication based on a network state or network state-related information.

According to a second aspect, a communication method is provided, including: performing, by a network device, communication based on a network state or network state-related information.

According to a third aspect, a terminal device is provided, including a transmission unit, configured to perform communication based on a network state or network state-related information.

According to a fourth aspect, a network device is provided, including a transmission unit, configured to perform communication based on a network state or network state-related information.

According to a fifth aspect, a terminal device is provided, including a memory, a transceiver, and a processor. The memory is configured to store a program, the processor performs data receiving and sending by using the transceiver, and the processor is configured to invoke the program in the memory, to cause the terminal device to execute the method according to the first aspect.

According to a sixth aspect, a network device is provided, including a memory, a transceiver, and a processor. The memory is configured to store a program, the processor performs data receiving and sending by using the transceiver, and the processor is configured to invoke the program in the memory, to cause the network device to execute the method according to the second aspect.

According to a seventh aspect, a terminal device is provided, including a processor, configured to invoke a program from a memory, to cause the terminal device to execute the method according to the first aspect.

According to an eighth aspect, a network device is provided, including a processor, configured to invoke a program from a memory, to cause the network device to execute the method according to the second aspect.

According to a ninth aspect, a chip is provided, including a processor, configured to invoke a program from a memory, to cause a device installed with the chip to execute the method according to the first aspect.

According to a tenth aspect, a chip is provided, including a processor, configured to invoke a program from a memory, to cause a device installed with the chip to execute the method according to the second aspect.

According to an eleventh aspect, a computer-readable storage medium is provided, where a program is stored on the computer-readable storage medium, and the program causes a computer to execute the method according to the first aspect.

According to a twelfth aspect, a computer-readable storage medium is provided, where a program is stored on the computer-readable storage medium, and the program causes a computer to execute the method according to the second aspect.

According to a thirteenth aspect, a computer program product is provided, including a program, where the program causes a computer to execute the method according to the first aspect.

According to a fourteenth aspect, a computer program product is provided, including a program, where the program causes a computer to execute the method according to the second aspect.

According to a fifteenth aspect, a computer program is provided, where the computer program causes a computer to execute the method according to the first aspect.

According to a sixteenth aspect, a computer program is provided, where the computer program causes a computer to execute the method according to the second aspect.

### BRIEF DESCRIPTION OF DRAWINGS

FIG. 1 is an example diagram of a wireless communications system to which embodiments of this application are applied.

FIG. 2 is a schematic flowchart of a communication method according to an embodiment of this application.

FIG. 3 is a schematic flowchart of a communication method according to another embodiment of this application.

FIG. 4 is a schematic diagram of a period or a pattern of an on-off switching state according to an embodiment of this application.

FIG. 5 is a schematic flowchart of a communication method according to still another embodiment of this application.

FIG. 6 is a schematic flowchart of a communication method according to still another embodiment of this application.

FIG. 7 is a schematic flowchart of a communication method according to still another embodiment of this application.

FIG. 8 is a schematic flowchart of a communication method according to still another embodiment of this application.

FIG. 9 is a schematic flowchart of a communication method according to still another embodiment of this application.

FIG. 10 is a schematic diagram of executing a BWP handover according to an embodiment of this application.

FIG. 11 is a schematic diagram of executing a BWP handover according to another embodiment of this application.

FIG. 12 is a schematic structural diagram of a communications apparatus according to an embodiment of this application.

FIG. 13 is a schematic structural diagram of a communications apparatus according to another embodiment of this application.

FIG. 14 is a schematic structural diagram of an apparatus according to an embodiment of this application.

### DESCRIPTION OF EMBODIMENTS

The technical solutions in this application are described below with reference to the accompanying drawings.

FIG. 1 shows a wireless communications system 100 to which embodiments of this application are applied. The wireless communications system 100 may include a network device 110 and user equipment (UE) 120. The network device 110 may communicate with the UE 120. The network device 110 may provide communication coverage for a specific geographic area, and may communicate with the UE 120 within the coverage area. The UE 120 may access a network (for example, a wireless network) by using the network device 110.

FIG. 1 exemplarily shows one network device and two UEs. In a possible implementation, the wireless communications system 100 may include a plurality of network devices, and another quantity of terminal devices may be included within a coverage range of each network device, which is not limited in embodiments of this application. In a possible implementation, the wireless communications system 100 may further include other network entities such as a network controller and a mobility management entity, which is not limited in embodiments of this application.

It should be understood that the technical solutions of embodiments of this application may be applied to various communications systems, such as a 5th generation (5G) system or new radio (NR), a long term evolution (LTE) system, an LTE frequency division duplex (FDD) system, LTE time division duplex (TDD), and a cellular internet of things. The technical solutions provided in this application may be further applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or an in-vehicle device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. In a possible implementation, the UE may be configured to function as a base station. For example, the UE may function as a scheduling entity that provides a sidelink signal between UEs in V2X, D2D, or the like. For example, a cellular phone and a vehicle communicate with each other by using a sidelink signal. A cellular phone and a smart household device communicate with each other, without relaying a communication signal by using a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover the following various names or replace with the following names, for example, a NodeB, an evolved NodeB (eNB), a next generation NodeB (gNB), a relay station, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the foregoing device or apparatus. Alternatively, the base station may be a mobile switching center, a device that functions as a base station in device-to-device (D2D), vehicle-to-everything (V2X), and machine-to-machine (M2M) communication, a network side device in a 6G network, a device that functions as a base station in a future communications system, or the like. The base station may support networks of a same access technology or different access technologies. A specific technology and a specific device form used by the network device are not limited in embodiments of this application.

In some embodiments, the network device may be fixed or mobile. For example, a helicopter or an unmanned aerial vehicle may be configured to function as a mobile network device, and one or more cells may move depending on a location of the mobile network device. In another example, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or in-vehicle, may be deployed on a water surface, or may be deployed on a plane, a balloon, or a satellite in the air. The network device and a scenario in which the network device is located in embodiments of this application are not limited in embodiments of this application.

It should also be understood that all or some of functions of the network device and the UE in this application may also be implemented by software functions running on hardware, or by virtualization functions instantiated on a platform (for example, a cloud platform).

To provide a higher data transmission rate and improve user experience, 5G NR further increases a system bandwidth based on 4G. In the 5G NR, for a frequency band below 6 GHz, a maximum bandwidth supported by a single carrier is 100 MHz; and for a frequency band above 6 GHz, a maximum bandwidth supported by a single carrier is 400 MHz. For a large carrier bandwidth such as 100 HMz, a bandwidth required by a terminal is often very limited. If the terminal needs to always perform detection and measurement in the entire bandwidth, power consumption of the terminal is greatly challenged, and power saving of the terminal is unfavorable. Therefore, a concept of a bandwidth part (BWP) is introduced in the 5G NR, that is, the entire bandwidth carrier is divided into a part of continuous bandwidth for the terminal device to receive and send data. The terminal device only needs to perform a related operation within this part of bandwidth configured by a network device, thereby saving energy of the terminal device.

Based on the 5G NR Rel-15 standard, for each serving cell of the terminal device, the network device may configure one or more BWPs in this serving cell for the terminal device by using a radio resource control (RRC) reconfiguration message, where a maximum quantity of configurable BWPs is 4. At each moment, the terminal device can have only one activated downlink (DL) BWP and one activated uplink (UL) BWP in this serving cell, and the terminal can receive and send data only on the activated BWP. Considering factors such as service diversity of the terminal device and a difference between different service features, the terminal device may need to adjust a BWP. For example, when a service volume of the terminal device is relatively large and it is expected to obtain a high-rate service, a large bandwidth BWP needs to be used to perform data transmission for the terminal device. When a service volume of the terminal device is relatively small, data transmission may be performed for the terminal device by using a small bandwidth BWP. The activated BWP in this serving cell for the terminal device may be changed by means of a BWP handover. There are currently four BWP handover methods supported in the standard.

### 1. BWP Handover Based on a Physical Downlink Control Channel (PDCCH)

This is a BWP handover controlled by the network device. The network device notifies, by sending a PDCCH scrambled by using a cell radio network temporary identifier (C-RNTI) to a single terminal device, the single terminal device of a target BWP to be handed over to.

### 2. BWP Handover Based on an RRC (Reconfiguration) Configuration Message

This is a BWP handover controlled by the network device. The network device indicates, by adding firstActiveDownlinkBWP-Id and/or firstActiveUplinkBWP-Id to the RRC (reconfiguration) configuration message, the terminal device to perform handover from the activated BWP to firstActiveDownlinkBWP-Id and/or firstActiveUplinkBWP-Id.

### 3. BWP Handover Based on Timer Timeout

This is an implicit BWP handover. The network device configures a timer bwp-InactivityTimer for each serving cell of the terminal device. If the currently activated DL BWP of the terminal device is a BWP other than a default BWP and an initial DL BWP, the timer bwp-InactivityTimer is started or restarted each time the terminal device receives, on the currently activated BWP, a PDCCH indicating the UE to perform uplink or downlink scheduling or the terminal device receives a PDCCH indicating the UE to perform uplink or downlink scheduling on the currently activated BWP. When the timer bwp-InactivityTimer expires, the terminal device is automatically performs handover from the BWP to the default BWP or the initial DL BWP. The default BWP and the initial BWP are determined by an RRC configuration.

### 4. BWP Handover Caused by Random Access Initialization

In a random access channel (RACH) initialization process, if the terminal device does not configure a PRACH occasion on the currently activated UL BWP, the terminal device automatically performs handover from the UL BWP to an initial UL BWP and performs handover from the DL BWP to an initial DL BWP.

In an LTE system and an NR system, a concept of a system message update period is also proposed. For example, when the network device needs to update a system message, the network device may first repeatedly send a system message update indication within the n^{th} system message update period, and then repeatedly send a changed system message within the (n+1)th system message update period. A boundary of the system message update period is defined as an SFN that meets a system frame number (SFN) mod m=0, where m is a quantity of SFNs included in one system message update period, m is an integer, and mod represents a modulo operation. m=modificationPeriodCoeff*defaultPagingCycle, where modificationPeriodCoeff and defaultPagingCycle are respectively a system message update cycle coefficient and a default paging cycle, and the two parameters are determined by the network device through broadcasting.

In the NR system, the system message update period is applicable to updating of a system message other than a system information block (SIB) 6, a SIB 7, a SIB 8, and positioning auxiliary data. In the NR, a short message in paging downlink control information (DCI) is used to notify a system information update indication, and a PDCCH in which the paging DCI is located is scrambled by a P-RNTI.

If a value of systemInfoModification in the short message is 1, it indicates that a system message other than a SIB 6, a SIB 7, and/or a SIB 8 needs to be updated, and therefore the terminal device obtains an updated system message in a next system message update period.

If a value of etwsAndCmasIndication in the short message is 1, it indicates that the network device needs to send an earthquake and tsunami warning system (ETWS) notification and/or a commercial mobile alert system (CMAS) notification, and therefore the terminal device reads a SIB 1, a SIB 6, a SIB 7, and/or a SIB 8 again immediately after receiving the short message.

For problems of frequent handovers and failure-prone handovers in a high-speed moving scenario and a high-frequency deployment scenario, a conditional handover (CHO) is further introduced in the LTE system and the NR system. A basic principle of the CHO is that the network device allocates a target cell to the terminal device in advance, where a handover (HO) command includes a condition for triggering a handover of the terminal device. When a condition related to the target cell is evaluated based on a condition configured on the network side and it is determined that the condition is to be triggered, the terminal device executes a handover to the target cell based on the preconfigured handover command (that is, triggers a random access process and sends a handover complete message), so as to avoid a problem that it is too late or impossible to send a measurement report and receive a handover command due to high-speed movement into a poor coverage area.

For the CHO, the network device may configure a plurality of candidate target cells in the HO command, and configure a CHO execution condition for each candidate target cell, where the CHO execution condition of each candidate target cell may include one or two trigger events. For example, an A3 event and an A5 event may be used as CHO events in the communications standard release 16 (Rel-16), and an A4 event may also be used as a CHO event in a non-terrestrial network (NTN) of the Rel-17. The terminal device may determine, based on the configured CHO execution condition, which target cell to access.

Currently, the NR supports the following several measurement events:
A1 event: signal quality of a serving cell is higher than a threshold;
A2 event: signal quality of a serving cell is lower than a threshold;
A3 event: signal quality of a neighboring cell is higher than signal quality of a special cell (SpCell) by a threshold;
A4 event: signal quality of a neighboring cell is higher than a threshold;
A5 event: signal quality of a SpCell is lower than a threshold 1, and signal quality of a neighboring cell is higher than a threshold 2;
A6 event: signal quality of a neighboring cell is higher than signal quality of a secondary cell (SCell) by a threshold;
B1 event: signal quality of an inter-system neighboring cell is higher than a threshold; and
B2 event: signal quality of a primary cell (PCell) is lower than a threshold 1, and signal quality of an inter-RAT neighboring cell is higher than a threshold 2.

In addition, for a problem of a frequent change of a primary secondary cell (PSCell) in a high-speed moving scenario and a high-frequency deployment scenario, a conditional PSCell change (CPC) is further introduced in the LTE system and the NR system. A basic principle of the CPC is that a secondary node SN) allocates a target cell to UE in advance, where a condition for triggering the UE to execute a PSCell change is included. The UE performs evaluation based on a condition configured on the network side, and when the configured condition is met, the UE initiates a PSCell change, so as to avoid a problem that it is too late or impossible to send a measurement report and receive a PSCell change command due to high-speed movement into a poor coverage area.

Similar to the CHO, for the CPC, the network device may configure a plurality of candidate target cells for the terminal device, and configure a CPC execution condition for each candidate target cell, where the CPC execution condition of each candidate target cell may include one or two trigger events. For example, an A3 event and an A5 event may be used as CPC events in the Rel-16. The terminal device may determine, based on the configured CPC execution condition, which target cell to access.

With development of communications technologies, energy consumption of a communications network is increasing and has become an important part of operating costs of an operator. However, at present, only a solution for energy saving of the terminal device is proposed, but a problem of network energy saving is not considered. Further, it is not clear how to support a handover (CHO), a BWP handover, broadcasting of a system message, and the like in a network energy saving scenario, or how to execute a handover (CHO), a BWP handover, broadcasting of a system message, and the like in a network energy saving scenario.

To resolve one or more of the foregoing technical problems, this application provides a communication method, a terminal device, and a network device.

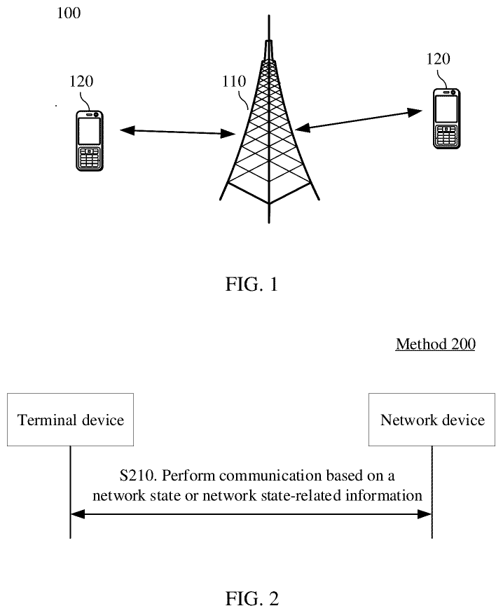

The following exemplarily describes embodiments of this application in detail with reference to FIG. 2 to FIG. 11.

FIG. 2 is a schematic flowchart of a communication method according to an embodiment of this application. The method 200 shown in FIG. 2 may include step S210. Details are as follows.

S210. A terminal device performs communication based on a network state or network state-related information. Correspondingly, a network device performs communication based on the network state or the network state-related information.

The network state may include at least one of an on state, an off state, an on-off switching state, a half-on state, a silence state, or a half-silence state that a first network device or a first cell is to be in.

In a possible implementation, in the on-off switching state, the first network device (or the first cell) may switch between an on state and an off state based on a preset period or a preset pattern. For example, the first cell may disable or enable a cell based on a pattern shown in FIG. 4.

In a possible implementation, in the half-on state, the first network device or the first cell may enable (or disable) transmission of only a part of the following signals: a synchronization signal block (SSB), system information, a reference signal (RS), a physical downlink control channel (PDCCH), downlink data, uplink data, a random access channel (RACH), and a scheduling request (SR). In other words, the half-on state may include a plurality of states, for example, a half-on state supporting an SSB, a half-on state supporting system information, a half-on state supporting system information and an RS, a sparse configuration or intermittent configuration state supporting an SSB, a sparse configuration or intermittent configuration state supporting system information, and a sparse configuration or intermittent configuration state supporting system information and an RS.

In a possible implementation, in the silence state, the first network device (or the first cell) may not disable a network device (or a cell), but stop all transmission of the network device (or the cell).

Similar to the half-on state, in the half-silence state, the first network device or the first cell may enable (or stop) transmission of only a part of the foregoing signals.

The network state-related information may include at least one of the following: a network state (for example, an on state, an off state, an on-off switching state, a half-on state, a silence state, or a half-silence state), duration of the on state, duration of the off state, a start moment of the on state, a start moment of the off state, an end moment of the on state, an end moment of the off state, a period of the on state, a quantity of times of maintaining the on state, a period of the off state, a quantity of times of maintaining the off state, a time of the half-on state (for example, at least one of start, end, duration, or a period), a time of the silence state (for example, at least one of start, end, duration, or a period), or a time of the half-silence state (for example, at least one of start, end, duration, or a period).

In a possible implementation, the first network device may be a network device in which the terminal device is currently located (for example, the first network device is a network device that provides a service for the terminal device) or a network device adjacent to the network device in which the terminal device is currently located, and the first cell may be a cell in which the terminal device is currently located (for example, the first cell is a serving cell of the terminal device) or a cell adjacent to the cell in which the terminal device is currently located. The network device or the cell in which the terminal device is currently located may be a cell or a network device that communicates with the terminal device.

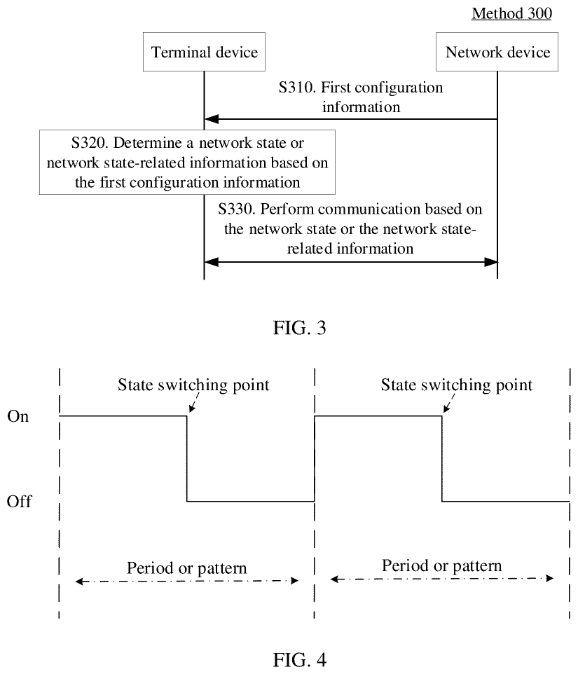

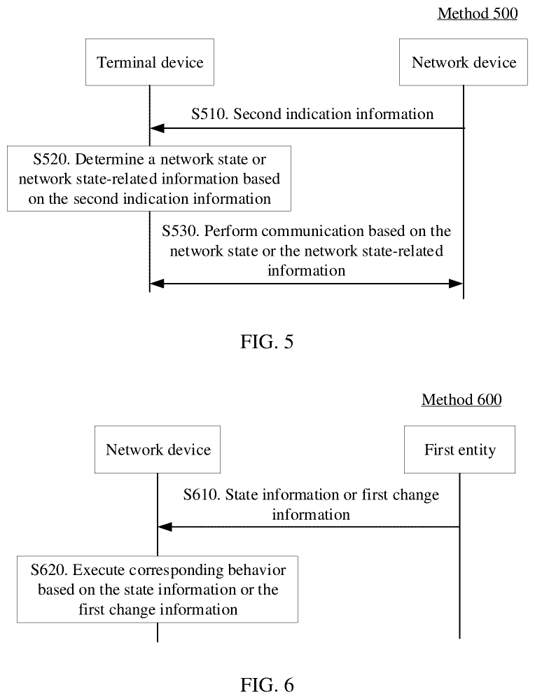

In this embodiment of this application, the terminal device may determine the network state and/or the network state-related information. For example, the terminal device may determine the network state and/or the network state-related information based on first configuration information or second indication information. The following describes in detail an embodiment of determining the network state and/or the network state-related information with reference to FIG. 3 and FIG. 5.

FIG. 3 is a schematic flowchart of a communication method according to an embodiment of this application. The method 300 shown in FIG. 3 may include steps S310, S320, and S330. Details are as follows.

S310. A terminal device obtains first configuration information. Correspondingly, a network device may send the first configuration information.

The first configuration information may be used to determine a network state and/or transmission by the terminal device.

In a possible implementation, the first configuration information may include at least one of the following:
the first configuration information is configured for or indicated to the terminal device in a static or semi-static manner; the first configuration information is for the terminal device (for example, UE-specific); the first configuration information is for a cell or a base station; the first configuration information is for a network device adjacent to a network device in which the terminal device is currently located or a cell adjacent to a cell in which the terminal device is currently located; or the first configuration information is for a network device in which the terminal device is currently located or a cell in which the terminal device is currently located. For example, when the first configuration information is configured for or indicated to the terminal device in a semi-static manner, the first configuration information may be configured for or indicated to the terminal device by using system information, RRC information, or dedicated information.

S320. The terminal device may determine a network state or network state-related information based on the first configuration information.

S330. The terminal device performs communication based on the network state or the network state-related information. Correspondingly, the network device performs communication based on the network state or the network state-related information.

In some possible implementations, the first configuration information may include a first parameter, and the first parameter may be used to indicate whether a terminal device that does not support network energy saving is capable of accessing a first network device or a first cell, or whether a terminal device that supports network energy saving is capable of accessing the first network device or the first cell. For example, the first parameter may include at least one of cellBarred, cellReservedForOtherUse, cellReservedForFutureUse, or a new bar parameter (that is, a defined bar parameter). Further, the terminal device may determine, based on the first parameter, whether to access the first network device or the first cell.

For example, a terminal device that supports network energy saving determines, based on the parameter cellBarred and the new bar parameter, whether the terminal device that supports network energy saving can access a network. For example, if cellBarred is set to barred and the new bar parameter is set to not barred, the terminal device that supports network energy saving can access the network. Otherwise, if cellBarred is set to barred and the new bar parameter is set to barred, the terminal device that supports network energy saving cannot access the network. For example, legacy UE or a terminal device that does not support network energy saving determines, based on cellBarred, whether the legacy UE or the terminal device that does not support network energy saving can access a network. For example, if cellBarred is set to barred, the legacy UE or the terminal device that does not support network energy saving cannot access the network. Otherwise, if cellBarred is set to not barred, the legacy UE or the terminal device that does not support network energy saving can access the network. For example, a terminal device that supports network energy saving determines, based on cellBarred, whether the terminal device that supports network energy saving can access a network. For example, if cellBarred is set to barred, the terminal device that supports network energy saving cannot access the network. Otherwise, if cellBarred is set to not barred, the terminal device that supports network energy saving can access the network.

In some possible implementations, the first configuration information may include at least one of the following: a network state indication or an entered network state (for example, an on state, an off state, an on-off switching state, a half-on state, a silence state, or a half-silence state), an on-off switching state indication, a period of the on-off switching state, a pattern of the on-off switching state, an on indication or an on state indication, an off indication or an off state indication, a time of the on state (for example, at least one of start, end, duration, or a period), a time of the off state (for example, at least one of start, end, duration, or a period), a time of the half-on state (for example, at least one of start, end, duration, or a period), a time of the silence state (for example, at least one of start, end, duration, or a period), or a time of the half-silence state (for example, at least one of start, end, duration, or a period).

In a possible implementation, the period of the on-off switching state may include at least one of the following: an on period, an off period, on duration, off duration, an on start moment, an off start moment, an on end moment, an off end moment, a switching period of the on-off switching state, an on-off switching period of the on-off switching state, a quantity of times of maintaining the on-off switching state, a start moment from the on state to the on-off switching state, an end moment from the on state to the on-off switching state, a start moment from the off state to the on-off switching state, an end moment from the off state to the on-off switching state, or a period of the pattern of the on-off switching state; the pattern of the on-off switching state may include at least one of the following: a start moment of the pattern, an end moment of the pattern, an on location in the pattern, or an off location in the pattern; the time of the on state may include at least one of the following: an on period, on duration, an on start moment, or an on end moment; the time of the off state may include at least one of the following: an off period, off duration, an off start moment, or an off end moment; the time of the half-on state may include at least one of the following: a period of the half-on state, duration of the half-on state, a start moment of the half-on state, or an end moment of the half-on state; the time of the silence state may include at least one of the following: a period of the silence state, duration of the silence state, a start moment of the silence state, or an end moment of the silence state; and the time of the half-silence state may include at least one of the following: a period of the half-silence state, duration of the half-silence state, a start moment of the half-silence state, or an end moment of the half-silence state. The quantity of times of maintaining the on-off switching state may be a quantity of times of keeping the on-off switching state or a quantity of times the on-off switching state is sustained. For example, assuming that one period of the on-off switching state is 10 ms, if the quantity of times of maintaining the on-off switching state is 5, the on-off switching state needs to be maintained for five times (50 ms).

In some possible implementations, the first configuration information may include the network state-related information. The network state-related information may indicate first indication information, or indicate whether to transmit the first indication information, or indicate transmission information for transmitting the first indication information, or indicate configuration information for transmitting the first indication information, or may be used to transmit the first indication information, or the network state-related information may be configuration information for indicating or requesting a network state, or signal information (for example, a reference signal), or signal configuration information, or content information that may be included in the first indication information. The first indication information is used by the terminal device or the network device to monitor whether the first network device or the first cell enters the on state, the off state, the on-off switching state, the half-on state, the silence state, or the half-silence state, or is used by the terminal device or the network device to indicate the network state that the first network device or the first cell enters, or is used by the terminal device or the network device to indicate that the first network device or the first cell enters the on state, the off state, the on-off switching state, the half-on state, the silence state, or the half-silence state.

In a possible implementation, the network state-related information may include at least one of the following: a first monitoring location, a first detection location, a first signal or a first reference signal, a first monitoring configuration, a first transmission location, and/or a first detection configuration, where the first monitoring location, the first detection location, the first signal or the first reference signal, the first monitoring configuration, the first transmission location, and/or the first detection configuration are/is used to configure the terminal device or the network device to perform monitoring, or are/is used by the terminal device or the network device to determine that the first network device or the first cell enters the on state, the off state, the on-off switching state, the half-on state, the silence state, or the half-silence state, or are/is used by the terminal device or the network device to send or receive the first indication information.

It should be noted that a location in embodiments of this application may include a time domain resource location and/or a frequency domain resource location. For example, the first monitoring location may include a time domain resource location and/or a frequency domain resource location. In embodiments of this application, monitoring may be monitoring a PDCCH, and detecting may be detecting a SIB and a reference signal. For example, the first monitoring location may be used to monitor a PDCCH, and the first detection location may be used to detect a SIB and a reference signal.

In a possible implementation, the first monitoring location, the first detection location, the first signal or the first reference signal, the first monitoring configuration, the first transmission location, and/or the first detection configuration may meet at least one of the following:
being within the on state, being within the off state, being within an on state in the on-off switching state, being within an off state in the on-off switching state, being within the half-on state, being within the silence state, or being within the half-silence state; being earlier than a period of the on-off switching state, being earlier than a pattern of the on-off switching state, being earlier than the on state, being earlier than the off state, being earlier than a state switching point within the on-off switching state, being earlier than the half-on state, being earlier than the silence state, or being earlier than the half-silence state; being within a preset time domain interval; or a fixed offset value existing with at least one of the on state, the off state, a period of the on-off switching state, a pattern of the on-off switching state, a state switching point within the on-off switching state, the half-on state, the silence state, or the half-silence state. For example, as shown in FIG. 4, the first monitoring location, the first detection location, the first signal or the first reference signal, the first monitoring configuration, the first transmission location, and/or the first detection configuration may be earlier than the period or the pattern of the on-off switching state, or may be earlier than the on state, or may be earlier than the off state, or may be earlier than the state switching point within the on-off switching state, or may be within the on state or the off state in the period or the pattern of the on-off switching state.

In a possible implementation, the first indication information may include at least one of the following: a switching indication or information, an on indication or information, an off indication or information, a half-on state indication or information, a silence state indication or information, a half-silence state indication or information, a synchronization signal block SSB, a reference signal RS, a physical downlink control channel PDCCH, a physical uplink control channel PUCCH, downlink data, uplink data, a random access channel RACH, semi-persistent scheduling SPS, a configured grant CG, or a scheduling request SR.

Further, the terminal device may send or receive the first indication information based on the first monitoring location, the first detection location, the first signal or the first reference signal, the first monitoring configuration, the first transmission location, and/or the first detection configuration. Correspondingly, the network device may receive or send the first indication information based on the first monitoring location, the first detection location, the first signal or the first reference signal, the first monitoring configuration, the first transmission location, and/or the first detection configuration.

In a possible implementation, the terminal device may send or receive at least one of the following information: a synchronization signal block SSB, a reference signal RS, a physical downlink control channel PDCCH, a physical uplink control channel PUCCH, downlink data, uplink data, a random access channel RACH, or a scheduling request SR after state switching, or after the first cell or the first network device is in the on state, or after the first cell or the first network device is in the X^{th} state (the X^{th} may be the half-on state, the silence state, or the half-silence state), or after a first monitoring location, a first detection location, a first signal or a first reference signal, a first monitoring configuration, a first transmission location, and/or a first detection configuration, or after the first indication information is sent or received. Correspondingly, the network device may receive or send the foregoing information.

In some possible implementations, the first configuration information may include second information, and the second information may be used to request the network device to send or start to send first information; and/or used by the network device to send or start to send the first information; and/or used by the terminal device to send or start to send the first information; and/or used by the terminal device to receive or start to receive the first information; and/or used by the network device to receive or start to receive the first information.

The first information is at least one of the following: a synchronization signal block SSB, a reference signal RS, a physical downlink control channel PDCCH, a physical uplink control channel PUCCH, downlink data, uplink data, a random access channel RACH, semi-persistent scheduling SPS, a configured grant CG, or a scheduling request SR.

In a possible implementation, the second information may include at least one of the following: a second monitoring location, a second detection location, a second monitoring configuration, a second transmission location, and/or a second detection configuration.

In a possible implementation, the second monitoring location, the second detection location, the second monitoring configuration, the second transmission location, and/or the second detection configuration may meet at least one of the following: being within the on state, being within the off state, being within an on state in the on-off switching state, being within an off state in the on-off switching state, being within the half-on state, being within the silence state, or being within the half-silence state; being earlier than a period of the on-off switching state, being earlier than a pattern of the on-off switching state, being earlier than the on state, being earlier than the off state, being earlier than a state switching point within the on-off switching state, being earlier than the half-on state, being earlier than the silence state, or being earlier than the half-silence state; being within a preset time domain interval; or a fixed offset value existing with at least one of the on state, the off state, a period of the on-off switching state, a pattern of the on-off switching state, a state switching point within the on-off switching state, the half-on state, the silence state, or the half-silence state. For example, as shown in FIG. 4, the second monitoring location, the second detection location, the second monitoring configuration, the second transmission location, and/or the second detection configuration may be earlier than the period or the pattern of the on-off switching state, or may be earlier than the state switching point within the on-off switching state, or may be within the on state or the off state in the period or the pattern of the on-off switching state.

In a possible implementation, the terminal device may send the first information to the network device based on the second information; or the terminal device may send the first information to the network device by using a configuration of the second information; or the terminal device may receive the first information from the network device based on the second information; or the terminal device may receive the first information from the network device by using a configuration of the second information. The configuration of the second information may include the second monitoring configuration and the second detection configuration.

In a possible implementation, that the terminal device sends the first information to the network device based on the second information may include at least one of the following:
sending, by the terminal device, the first information to the network device before state switching; sending, by the terminal device, the first information to the network device before the first network device or the first cell is on; sending, by the terminal device, the first information to the network device before the first network device or the first cell is in the X^{th} state (the X^{th} state may be the half-on state, the silence state, or the half-silence state); sending, by the terminal device, the first information to the network device after the second monitoring configuration or the second detection configuration is received, or after the second monitoring location, the second detection location, or the second transmission location; receiving, by the terminal device, the first information from the network device after the second monitoring configuration or the second detection configuration is received, or after the second monitoring location, the second detection location, or the second transmission location; sending, by the terminal device, the first information to the network device at a start moment of receiving the second monitoring configuration or the second detection configuration, or at a start moment of the second monitoring location, the second detection location, or the second transmission location; or receiving, by the terminal device, the first information from the network device at a start moment of receiving the second monitoring configuration or the second detection configuration, or at a start moment of the second monitoring location, the second detection location, or the second transmission location.

In some possible implementations, the first configuration information may include a transmission configuration of third information.

The transmission configuration of the third information may include at least one of the following: a first transmission configuration, a second transmission configuration, or a third transmission configuration, where the first transmission configuration includes a configuration in which the terminal device transmits the third information in the on state, the second transmission configuration includes a configuration in which the terminal device transmits the third information in the off state, and the third transmission configuration includes a configuration in which the terminal device transmits the third information in the on-off switching state.

In a possible implementation, the transmission configuration of the third information may be further used in combination with second indication information in the subsequent method 500. For example, the terminal device may transmit information or a signal to the network device based on the first configuration information. For detailed descriptions of the second indication information, refer to the embodiment in the method 500. For example, the terminal device may further receive the second indication information sent by the network device. In a case that the second indication information indicates that the first network device or the first cell enters the on state, the off state, the half-on state, the silence state, or the half-silence state, the terminal device may transmit at least one of third information, fifth information, tenth information, eleventh information, twelfth information, or thirteenth information to the network device based on at least one of the first transmission configuration, the second transmission configuration, or the third transmission configuration.

The first transmission configuration may include a first configuration and/or a first period. The first configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the first period includes at least one of the following: a period of SSB transmission, a period of RS transmission, a period of a PDCCH, a period of SR transmission, a period of a CG, or a period of SPS.

The second transmission configuration may include a second configuration and/or a second period. The second configuration includes at least one of the following: a configuration of an SSB, a configuration of an RS, a configuration of a PDCCH, a configuration of SR transmission, a configuration of a CG, a configuration of SPS, or a configuration of a RACH or a PRACH, and the second period includes at least one of the following: a period of SSB transmission, a period of RS transmission, a period of a PDCCH, a period of SR transmission, a period of a CG, or a period of SPS.

The third transmission configuration may include a third configuration and/or a third period. The third configuration includes at least one of the following: a configuration of an SSB, a configuration of an RS, a configuration of a PDCCH, a configuration of SR transmission, a configuration of a CG, a configuration of SPS, or a configuration of a RACH or a PRACH, and the third period includes at least one of the following: a period of SSB transmission, a period of RS transmission, a period of a PDCCH, a period of SR transmission, a period of a CG, or a period of SPS.

In a possible implementation, the first configuration may be different from the second configuration, and/or the first period may be different from the second period, and/or the first period may be less than the second period, and/or a quantity of resources in the first configuration may be greater than a quantity of resources in the second configuration, and/or a quantity of resources in the first configuration may be different from a quantity of resources in the second configuration, and/or a resource in the first configuration may be greater than a resource in the second configuration, and/or the third configuration is different from the second configuration, and/or the third configuration is different from the first configuration, and/or the third period is different from the second period, and/or the third period is different from the first period, and/or the third period is greater than the second period, and/or a quantity of resources in the third configuration is less than a quantity of resources in the second configuration, and/or a quantity of resources in the third configuration is different from a quantity of resources in the second configuration, and/or a resource in the third configuration is less than a resource in the second configuration, and/or the third period is greater than the first period, and/or a quantity of resources in the third configuration is less than a quantity of resources in the first configuration, and/or a quantity of resources in the third configuration is different from a quantity of resources in the first configuration, and/or a resource in the third configuration is less than a resource in the first configuration.

In a possible implementation, the terminal device may send or receive the third information based on the network state and based on the first transmission configuration and/or the second transmission configuration. Correspondingly, the network device may receive or send the third information.

The third information may be at least one of the following: a synchronization signal block SSB, system information, a reference signal RS, a physical downlink control channel PDCCH, a PUCCH, downlink data, uplink data, a random access channel RACH, SPS, a CG, or a scheduling request SR.

In a possible implementation, the terminal device may send or receive the third information based on the first transmission configuration within the on state or within an on state in the on-off switching state; and the terminal device may send or receive the third information based on the second transmission configuration within the off state or an off state in the on-off switching state. Correspondingly, the network device may receive or send the third information based on the first transmission configuration within the on state or within an on state in the on-off switching state; and the network device may receive or send the third information based on the second transmission configuration within the off state or an off state in the on-off switching state.

In a possible implementation, the terminal device may send or receive the third information within the on state or within an on state in the on-off switching state; and the terminal device may not send or receive the third information within the off state or an off state in the on-off switching state. Correspondingly, the network device may receive or send the third information within the on state or within an on state in the on-off switching state; and the network device may not receive or send the third information within the off state or an off state in the on-off switching state.

Further, in some other possible implementations, the transmission configuration of the third information may include at least one of the following: a first transmission configuration, a second transmission configuration, or a third transmission configuration, where the first transmission configuration includes a configuration in which the terminal device transmits the third information in the on state, the second transmission configuration includes a configuration in which the terminal device transmits the third information in the off state, and the third transmission configuration includes a configuration in which the terminal device transmits the third information in the on-off switching state.

In a possible implementation, the third configuration may be different from the second configuration, and/or the third configuration may be different from the first configuration, and/or the third period may be different from the second period, and/or the third period may be different from the first period, and/or the third period may be greater than the second period, and/or a quantity of resources in the third configuration may be less than a quantity of resources in the second configuration, and/or a quantity of resources in the third configuration may be different from a quantity of resources in the second configuration, and/or a resource in the third configuration may be less than a resource in the second configuration, and/or the third period may be greater than the first period, and/or a quantity of resources in the third configuration may be less than a quantity of resources in the first configuration, and/or a quantity of resources in the third configuration may be different from a quantity of resources in the first configuration, and/or a resource in the third configuration may be less than a resource in the first configuration.

In a possible implementation, the terminal device may send or receive the third information based on the network state and based on the first transmission configuration and/or the second transmission configuration and/or the third transmission configuration. Correspondingly, the network device may receive or send the third information.

In a possible implementation, the terminal device may send or receive the third information based on the first transmission configuration in the on state; the terminal device may send or receive the third information based on the second transmission configuration in the off state; and the terminal device may send or receive the third information based on the third transmission configuration in the on-off switching state. Correspondingly, the network device may receive or send the third information based on the first transmission configuration in the on state; the network device may receive or send the third information based on the second transmission configuration in the off state; and the network device may receive or send the third information based on the third transmission configuration in the on-off switching state.

In some possible implementations, the first configuration information may include a transmission configuration of tenth information.

In a possible implementation, the transmission configuration of the tenth information may include at least two configurations, and the at least two configurations correspond to at least two network states.

In a possible implementation, the transmission configuration of the tenth information may include at least a seventh transmission configuration and an eighth transmission configuration, or the transmission configuration of the tenth information may include at least a seventh transmission configuration, an eighth transmission configuration, and a ninth transmission configuration, where the seventh transmission configuration may include a configuration in which the terminal device transmits the tenth information in a first state, the eighth transmission configuration may include a configuration in which the terminal device transmits the tenth information in a second state, and the ninth transmission configuration may include a configuration in which the terminal device transmits the tenth information in a third state. Certainly, the transmission configuration of the tenth information may include more transmission configurations (for example, four, five, or more transmission configurations, and these transmission configurations may be in a one-to-one correspondence with a plurality of network states), which is not limited in embodiments of this application.

The first state, the second state, and the third state may meet any one of the following:
the first state is an on state, the second state is a half-on state, and the third state is an off state;
the first state is an on state, the second state is a silence state, and the third state is an off state; or
the first state is an on state, the second state is a half-silence state, and the third state is a silence state.

In a possible implementation, the transmission configuration of the tenth information may be further used in combination with second indication information in the subsequent method 500. For example, the terminal device may transmit the tenth information to the network device based on the first configuration information. For detailed descriptions of the second indication information, refer to the embodiment in the method 500. For example, the terminal device may further receive the second indication information sent by the network device. In a case that the second indication information indicates that the first network device or the first cell enters the on state, the off state, the half-on state, the silence state, or the half-silence state, the terminal device may transmit at least one of third information, fifth information, tenth information, eleventh information, twelfth information, or thirteenth information to the network device based on at least one of the seventh transmission configuration, the eighth transmission configuration, or the ninth transmission configuration.

The seventh transmission configuration may include a seventh configuration and/or a seventh period. The seventh configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the seventh period includes at least one of the following: a period of SSB transmission, a period of RS transmission, a period of a PDCCH, a period of SR transmission, a period of a CG, or a period of SPS.

The eighth transmission configuration may include an eighth configuration and/or an eighth period. The eighth configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the eighth period includes at least one of the following: a period of SSB transmission, a period of RS transmission, a period of a PDCCH, a period of SR transmission, a period of a CG, or a period of SPS.

The ninth transmission configuration may include a ninth configuration and/or a ninth period. The ninth configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the ninth period includes at least one of the following: a period of SSB transmission, a period of RS transmission, a period of a PDCCH, a period of SR transmission, a period of a CG, or a period of SPS.

In a possible implementation, the seventh configuration may be different from the eighth configuration, and/or the seventh period may be different from the eighth period, and/or the seventh period may be less than the eighth period, and/or a quantity of resources in the seventh configuration may be greater than a quantity of resources in the eighth configuration, and/or a quantity of resources in the seventh configuration may be different from a quantity of resources in the eighth configuration, and/or a resource in the seventh configuration may be greater than a resource in the eighth configuration.

In a possible implementation, the seventh configuration may be different from the ninth configuration, and/or the seventh period may be different from the ninth period, and/or the seventh period is less than the ninth period, and/or a quantity of resources in the seventh configuration is greater than a quantity of resources in the ninth configuration, and/or a quantity of resources in the seventh configuration is different from a quantity of resources in the ninth configuration, and/or a resource in the seventh configuration is greater than a resource in the ninth configuration.

In a possible implementation, the eighth configuration is different from the ninth configuration, and/or the eighth period is different from the ninth period, and/or the eighth period may be less than the ninth period, and/or a quantity of resources in the eighth configuration may be greater than a quantity of resources in the ninth configuration, and/or a quantity of resources in the eighth configuration may be different from a quantity of resources in the ninth configuration, and/or a resource in the eighth configuration may be greater than a resource in the ninth configuration.

Further, the terminal device may send or receive the tenth information based on the network state and based on a transmission configuration corresponding to the network state.

In a possible implementation, the tenth information may be at least one of the following: a synchronization signal block SSB, system information, a reference signal RS, a PDCCH, a PUCCH, downlink data, uplink data, a random access channel RACH, SPS, a CG, or a scheduling request SR.

In some possible implementations, the first configuration information may include a tenth transmission configuration.

The tenth transmission configuration may be used to transmit at least two pieces of information, and the at least two pieces of information may correspond to at least two network states.

In a possible implementation, the tenth transmission configuration may be further used in combination with second indication information in the subsequent method 500. For detailed descriptions of the second indication information, refer to the embodiment in the method 500. For example, the terminal device may further receive the second indication information sent by the network device. In a case that the second indication information indicates that the first network device or the first cell enters the on state, the off state, the half-on state, the silence state, or the half-silence state, the terminal device may transmit at least one of third information, fifth information, tenth information, eleventh information, twelfth information, or thirteenth information to the network device based on the tenth transmission configuration.

In a possible implementation, the tenth transmission configuration may be used to transmit at least one of the eleventh information, the twelfth information, or the thirteenth information.

In a possible implementation, the tenth transmission configuration may be used to transmit at least eleventh information and twelfth information, where the eleventh information may be information transmitted by the terminal device in a first state, and the twelfth information may be information transmitted by the terminal device in a second state.

Alternatively, the tenth transmission configuration may be used to transmit at least eleventh information and twelfth information, where the eleventh information may be information transmitted by the terminal device in a first state, and the twelfth information may be information transmitted by the terminal device in a third state.

Alternatively, the tenth transmission configuration may be used to transmit at least thirteenth information and twelfth information, where the twelfth information may be information transmitted by the terminal device in a second state, and the thirteenth information may be information transmitted by the terminal device in a third state.

Alternatively, the tenth transmission configuration may be used to transmit at least eleventh information, twelfth information, and thirteenth information, where the eleventh information may be information transmitted by the terminal device in a first state, the twelfth information may be information transmitted by the terminal device in a second state, and the thirteenth information may be information transmitted by the terminal device in a third state.

Alternatively, the tenth transmission configuration may be used to transmit at least one of eleventh information, twelfth information, or thirteenth information, where the eleventh information may be information transmitted by the terminal device in a first state, the twelfth information may be information transmitted by the terminal device in a second state, and the thirteenth information may be information transmitted by the terminal device in a third state.

In a possible implementation, at least one of the eleventh information, the twelfth information, or the thirteenth information may be at least one of the following: an SSB, system information, an RS, a PDCCH, a PUCCH, downlink data, uplink data, a RACH, SPS, a CG, or an SR.

In a possible implementation, at least two of the eleventh information, the twelfth information, and the thirteenth information may be in a same relationship or different relationships.

In a possible implementation, the tenth transmission configuration may include a tenth configuration and/or a tenth period. The tenth configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the tenth period includes at least one of the following: a period of SSB transmission, a period of RS transmission, a period of a PDCCH, a period of SR transmission, a period of a CG, or a period of SPS.

In a possible implementation, tenth transmission configurations corresponding to at least two of the eleventh information, the twelfth information, and the thirteenth information may be in a same relationship or different relationships.

In a possible implementation, a relationship between at least two of the eleventh information, the twelfth information, and the thirteenth information may be at least one of the following: the thirteenth information is a subset or a full set of the twelfth information, the twelfth information is a subset or a full set of the eleventh information, or the thirteenth information is a subset or a full set of the eleventh information.

In a possible implementation, a relationship between tenth transmission configurations corresponding to at least two of the eleventh information, the twelfth information, and the thirteenth information may be at least one of the following: a tenth transmission configuration corresponding to the thirteenth information is a subset or a full set of a tenth transmission configuration corresponding to the twelfth information, the tenth transmission configuration corresponding to the twelfth information is a subset or a full set of a tenth transmission configuration corresponding to the eleventh information, or the tenth transmission configuration corresponding to the thirteenth information is a subset or a full set of the tenth transmission configuration corresponding to the eleventh information.

In a possible implementation, the terminal device may send or receive, based on the network state, information corresponding to the network state.

In the foregoing application, at least a part of network states in different network states may correspond to different transmission configurations, and/or at least a part of network states in different network states may correspond to different information.

In a possible implementation, the terminal device may further receive the second indication information sent by the network device. In a case that the second indication information indicates that the first network device or the first cell enters the on state, the off state, the half-on state, the silence state, or the half-silence state, the terminal device may transmit at least one of third information, fifth information, tenth information, eleventh information, twelfth information, or thirteenth information to the network device based on at least one of the seventh transmission configuration, the eighth transmission configuration, the ninth transmission configuration, or the tenth transmission configuration.

In some possible implementations, the terminal device may report auxiliary information (for example, fourth information) to the network device. For example, the terminal device may send the fourth information to the network device, where the fourth information may be used to determine the network state of the first network device or the first cell. Correspondingly, the network device may receive the fourth information.

The fourth information may include at least one of the following: a service feature, mobility, or a location of the terminal device. The mobility may be used to indicate a moving range of the terminal device within preset duration. For example, assuming that a moving distance of the terminal device within one hour is less than 100 meters, it may be considered that the mobility of the terminal device is relatively low or the location of the terminal device is relatively fixed. Assuming that a moving distance of the terminal device within one hour is less than 1000 meters, it may be considered that the mobility of the terminal device is relatively high or the location of the terminal device is not fixed.

In a possible implementation, the fourth information may further include duration in which the terminal device does not transmit a scheduling request SR or duration in which the terminal device does not use a configured grant (CG). In a possible implementation, the fourth information may further include time information in which the terminal device does not transmit a scheduling request SR or time information in which the terminal device does not use a configured grant (CG). For example, the time information may include a start time, an end time, and the like.

In a possible implementation, the terminal device may send the fourth information to the network device by using an RRC message, a media access control control element MAC CE, or uplink control information (UCI).

In a possible implementation, the terminal device may send the fourth information to the network device at a specific moment or in a specific time period. The specific moment or the specific time period is before network state switching, before an off state, before an off state in a state switching pattern, before an on state, before an on state in a state switching pattern, within any network state, or within a specific network state (for example, a half-on state, a silence state, or a half-silence state).

In this embodiment of this application, a network state-based mechanism or configuration is provided, or an on-off switching mechanism or configuration is provided, so that energy saving of the network device can be ensured, and impact on measurement, transmission, and the like of the terminal device can be avoided.

FIG. 5 is a schematic flowchart of a communication method according to an embodiment of this application. The method 500 shown in FIG. 5 may include steps S510, S520, and S530. Details are as follows.

S510. A terminal device receives second indication information. Correspondingly, a network device may send the second indication information.

The second indication information may be used to indicate network state-related information, or may be used to indicate a network state that a first network device or a first cell enters, or may be used to indicate whether the first network device or the first cell enters an on state, an off state, a half-on state, a silence state, or a half-silence state.

In a possible implementation, the second indication information includes at least one of the following:
the second indication information is configured for or indicated to the terminal device by using system information or dedicated information; the second indication information is configured for or indicated to the terminal device by using a MAC CE or DCI or a PDCCH; the second indication information is dynamically configured for or indicated to the terminal device; the second indication information is for the terminal device; the second indication information is for a base station or a cell; the second indication information is for a network device adjacent to a network device in which the terminal device is currently located or a cell adjacent to a cell in which the terminal device is currently located; or the second indication information is for a network device in which the terminal device is currently located or a cell in which the terminal device is currently located.

S520. The terminal device may determine the network state or the network state-related information based on the second indication information.

S530. The terminal device performs communication based on the network state or the network state-related information. Correspondingly, the network device performs communication based on the network state or the network state-related information.

In some possible implementations, the second indication information may include a second parameter, and the second parameter may be used to indicate whether a terminal device that does not support network energy saving is capable of accessing the first network device or the first cell, or whether a terminal device that supports network energy saving is capable of accessing the first network device or the first cell. For example, the second parameter may include at least one of cellBarred, cellReservedForOtherUse, cellReservedForFutureUse, or a new bar parameter.

Further, the terminal device may determine, based on the second parameter, whether to access the first network device or the first cell.

For example, a terminal device that supports network energy saving determines, based on cellBarred and the new bar parameter, whether the terminal device that supports network energy saving can access a network. For example, if cellBarred is set to barred and the new bar parameter is set to not barred, the terminal device that supports network energy saving can access the network. Otherwise, if cellBarred is set to barred and the new bar parameter is set to barred, the terminal device that supports network energy saving cannot access the network. For example, legacy UE or a terminal device that does not support network energy saving determines, based on cellBarred, whether the legacy UE or the terminal device that does not support network energy saving can access a network. For example, if cellBarred is set to barred, the legacy UE or the terminal device that does not support network energy saving cannot access the network. Otherwise, if cellBarred is set to not barred, the legacy UE or the terminal device that does not support network energy saving can access the network. For example, a terminal device that supports network energy saving determines, based on cellBarred, whether the terminal device that supports network energy saving can access a network. For example, if cellBarred is set to barred, the terminal device that supports network energy saving cannot access the network. Otherwise, if cellBarred is set to not barred, the terminal device that supports network energy saving can access the network.

In some possible implementations, the second indication information may be used for transmitting fifth information.

In a possible implementation, the network state-related information may include a transmission configuration of fifth information.

In a possible implementation, the transmission configuration of the fifth information may include a fourth transmission configuration and/or a fifth transmission configuration, where the fourth transmission configuration may include a configuration in which the terminal device transmits the fifth information in the on state, and the fifth transmission configuration may include a configuration in which the terminal device transmits the fifth information in the off state.

The fourth transmission configuration may include a fourth configuration and/or a fourth period. The fourth configuration includes at least one of the following: a configuration of a synchronization signal block SSB, a configuration of a reference signal RS, a configuration of a physical downlink control channel PDCCH, a configuration of scheduling request SR transmission, a configuration of a configured grant CG, a configuration of semi-static scheduling SPS, a configuration of a random access channel RACH, or a configuration of a physical random access channel PRACH, and the fourth period includes at least one of the following: a period of SSB transmission, a period of RS transmission, a period of a PDCCH, a period of SR transmission, a period of a CG, or a period of SPS.

The fifth transmission configuration may include a fifth configuration and/or a fifth period. The fifth configuration includes at least one of the following: a configuration of an SSB, a configuration of an RS, a configuration of a PDCCH, a configuration of SR transmission, a configuration of a CG, a configuration of SPS, or a configuration of a RACH or a PRACH, and the fifth period includes at least one of the following: a period of SSB transmission, a period of RS transmission, a period of a PDCCH, a period of SR transmission, a period of a CG, or a period of SPS.

In a possible implementation, the fourth configuration may be different from the fifth configuration, and/or the fourth period may be different from the fifth period, and/or the fourth period may be less than the fifth period, and/or a quantity of resources in the fourth configuration may be greater than a quantity of resources in the fifth configuration, and/or a quantity of resources in the fourth configuration may be different from a quantity of resources in the fifth configuration, and/or a resource in the fourth configuration may be greater than a resource in the fifth configuration.

In a possible implementation, the terminal device may send or receive the fifth information based on the network state and based on the fourth transmission configuration and/or the fifth transmission configuration. Correspondingly, the network device may receive or send the fifth information.

In a possible implementation, the fifth information may include at least one of the following: cell common information or terminal device dedicated information.

In a possible implementation, the fifth information may be at least one of the following: a synchronization signal block SSB, system information, a reference signal RS, a PDCCH, a PUCCH, downlink data, uplink data, a random access channel RACH, SPS, a CG, or a scheduling request SR.

In a possible implementation, the terminal device may send or receive the fifth information based on the fourth transmission configuration within the on state or within an on state in the on-off switching state; and the terminal device may send or receive the fifth information based on the fifth transmission configuration within the off state or an off state in the on-off switching state. Correspondingly, the network device may receive or send the fifth information based on the fourth transmission configuration within the on state or within an on state in the on-off switching state; and the network device may receive or send the fifth information based on the fifth transmission configuration within the off state or an off state in the on-off switching state.

In a possible implementation, the terminal device may send or receive the fifth information within the on state or within an on state in the on-off switching state; and the terminal device may not send or receive the fifth information within the off state or an off state in the on-off switching state. Correspondingly, the network device may receive or send the fifth information within the on state or within an on state in the on-off switching state; and the network device may not receive or send the fifth information within the off state or an off state in the on-off switching state.

Further, in some other possible implementations, the transmission configuration of the fifth information may include at least one of the following: a fourth transmission configuration, a fifth transmission configuration, or a sixth transmission configuration, where the fourth transmission configuration includes a configuration in which the terminal device transmits the fifth information in the on state, the fifth transmission configuration includes a configuration in which the terminal device transmits the fifth information in the off state, and the sixth transmission configuration includes a configuration in which the terminal device transmits the fifth information in the on-off switching state.

The sixth transmission configuration may include a sixth configuration and/or a sixth period. The sixth configuration includes at least one of the following: a configuration of an SSB, a configuration of an RS, a configuration of a PDCCH, a configuration of SR transmission, a configuration of a CG, a configuration of SPS, or a configuration of a RACH or a PRACH, and the sixth period includes at least one of the following: a period of SSB transmission, a period of RS transmission, a period of a PDCCH, a period of SR transmission, a period of a CG, or a period of SPS.

In a possible implementation, the sixth configuration may be different from the fifth configuration, and/or the sixth configuration may be different from the fourth configuration, and/or the sixth period may be different from the fifth period, and/or the sixth period may be different from the fourth period, and/or the sixth period may be greater than the fifth period, and/or a quantity of resources in the sixth configuration may be less than a quantity of resources in the fifth configuration, and/or a quantity of resources in the sixth configuration may be different from a quantity of resources in the fifth configuration, and/or a resource in the sixth configuration may be less than a resource in the fifth configuration, and/or the sixth period may be greater than the fourth period, and/or a quantity of resources in the sixth configuration may be less than a quantity of resources in the fourth configuration, and/or a quantity of resources in the sixth configuration may be different from a quantity of resources in the fourth configuration, and/or a resource in the sixth configuration may be less than a resource in the fourth configuration.

In a possible implementation, the terminal device may send or receive the fifth information based on the network state and based on the fourth transmission configuration and/or the fifth transmission configuration and/or the sixth transmission configuration. Correspondingly, the network device may receive or send the fifth information.

In a possible implementation, the terminal device may send or receive the fifth information based on the fourth transmission configuration in the on state; the terminal device may send or receive the fifth information based on the fifth transmission configuration in the off state; and the terminal device may send or receive the fifth information based on the sixth transmission configuration in the on-off switching state. Correspondingly, the network device may receive or send the fifth information based on the fourth transmission configuration in the on state; the network device may receive or send the fifth information based on the fifth transmission configuration in the off state; and the network device may receive or send the fifth information based on the sixth transmission configuration in the on-off switching state.

In some possible implementations, the terminal device may further report auxiliary information (for example, sixth information) to the network device. For example, the terminal device may send the sixth information to the network device, where the sixth information may be used to determine the network state of the first network device or the first cell. Correspondingly, the network device may receive the sixth information.

The sixth information may include at least one of the following: a service feature, mobility, or a location of the terminal device. The mobility may be used to indicate a moving range of the terminal device within preset duration.

In a possible implementation, the sixth information may further include duration in which the terminal device does not transmit a scheduling request SR or duration in which the terminal device does not use a configured grant (CG). In a possible implementation, the sixth information may further include time information in which the terminal device does not transmit a scheduling request SR or time information in which the terminal device does not use a configured grant (CG). For example, the time information may include a start time, an end time, and the like.

In a possible implementation, the terminal device may send the sixth information to the network device by using an RRC message, a media access control control element MAC CE, or uplink control information (UCI).

In a possible implementation, the terminal device may send the sixth information to the network device at a specific moment or in a specific time period. The specific moment or the specific time period is before network state switching, before an off state, before an off state in a state switching pattern, before an on state, before an on state in a state switching pattern, within any network state, or within a specific network state (for example, a half-on state, a silence state, or a half-silence state).

In some possible implementations, the second indication information may be used in combination with the first monitoring location, the first detection location, the first signal or the first reference signal, the first monitoring configuration, the first transmission location, and/or the first detection configuration, and/or the second monitoring location, the second detection location, the second monitoring configuration, the second transmission location, and/or the second detection configuration in the foregoing embodiment.

For example, in the first monitoring location, if the terminal device determines or indicates that the first cell executes on-off switching, the network device sends the second indication information to the terminal device, to dynamically indicate that the first cell enters the on state.

For example, in the first monitoring location, if the terminal device determines or indicates that the first cell is switched to the on state or the half-on state, the network device sends the second indication information to the terminal device, to dynamically indicate that the first cell is switched to the on state or the half-on state.

For example, the second indication information indicates that the first cell is switched to the on state or the half-on state. Before the first cell is switched to the on state or the half-on state, the terminal device sends first information, where the first information may be used for measurement or scheduling reference, so that measurement information or scheduling reference information can be ensured when the first cell executes on/off state switching.

For example, the second indication information indicates that the first cell executes on/off state switching. Before the first cell executes on/off state switching, the terminal device sends first information, where the first information may be used for measurement or scheduling reference, so that measurement information or scheduling reference information can be ensured when the first cell executes on/off state switching.

In this embodiment of this application, a manner of dynamically indicating a network state or a manner of dynamically indicating on or off is provided, so that energy saving of the network device can be ensured, and impact on measurement, transmission, and the like of the terminal device can be flexibly avoided.

FIG. 6 is a schematic flowchart of a communication method according to an embodiment of this application. The method 600 shown in FIG. 6 may include steps S610 and S620. Details are as follows.

S610. A network device receives state information or first change information of a second network device or a second cell and sent by a first entity.

And/or a network device may request state information or first change information from a first entity, or send state information or first change information to a first entity. For example, in a handover process or a handover preparation process or a handover request process or a handover execution process, or after a handover command is sent, or before a handover command is sent, or before a handover is triggered or executed, the network device may request the state information or the first change information from the first entity, or send the state information or the first change information to the first entity.

And/or a network device sends state information or first change information of a current network device or a cell of the current network device to a first entity.

The state information or the first change information may include at least one of the following:
a network state indication, an on start moment, an off start moment, on duration, off duration, an on end moment, an off end moment, a period of an on state, a quantity of times of maintaining an on state, a period of an off state, a quantity of times of maintaining an off state, a time of a half-on state (for example, at least one of start, end, duration, or a period), a time of a second state (for example, at least one of start, end, duration, or a period), or a time of a third state (for example, at least one of start, end, duration, or a period).

In a possible implementation, after obtaining the state information or the first change information of the second network device or the second cell, the first entity may send the state information or the first change information of the second network device or the second cell to the network device.

In a possible implementation, the first entity may send or receive state information or first change information of a cell or a network device other than a current network device or a current cell.

The network device may be a base station. In a possible implementation, the network device may be at least one of a source base station, a target base station, or a candidate target base station, or the state information or the first change information may be for at least one of a source base station, a target base station, or a candidate target base station. The first entity may be at least one of the following: a terminal device, a second network device, a third network device, or an operation, administration and maintenance entity (OAM).

The second network device may be a network device in which the terminal device is currently located or a network device adjacent to the network device in which the terminal device is currently located, and the second cell may be a cell in which the terminal device is currently located or a cell adjacent to the cell in which the terminal device is currently located.

In some possible implementations, the network device may receive state information or first change information of a second network device or a second cell and sent by the second network device; or the network device may send state information or first change information of a second network device or a second cell to the second network device; or the network device may receive state information or first change information of a third network device or a third cell and sent by a second network device; or the network device may send state information or first change information of the network device or a cell of the network device to a second network device.

In some possible implementations, the network device may receive state information or first change information of a second network device or a second cell and sent by the terminal device; or the network device may send state information or first change information of a second network device or a second cell to the terminal device.

In some possible implementations, the network device may receive state information or first change information of a second network device or a second cell and sent by an OAM entity; or the network device may send state information or first change information of a second network device or a second cell to an OAM entity.

In some possible implementations, the network device may send state information or first change information of a second network device or a second cell to the terminal device; or the network device may receive state information or first change information of a second network device or a second cell and sent by the terminal device.

In a possible implementation, in the foregoing embodiment, the network device may transmit state information or first change information in at least one of the following manners:
receiving, by the network device, state information or first change information after a handover command is sent or in a handover request process; sending, by the network device, state information or first change information after a handover command is sent or in a handover request process; receiving, by the network device, state information or first change information before a handover process is executed or triggered; sending, by the network device, state information or first change information before a handover process is executed or triggered; receiving, by the network device, state information or first change information in a handover process; sending, by the network device, state information or first change information in a handover process; receiving, by the network device, state information or first change information of a current network device or a current cell or another network device or another cell before a handover process is executed or triggered; sending, by the network device, state information or first change information of a current network device or a current cell or another network device or another cell before a handover process is executed or triggered; receiving, by the network device, state information or first change information of a current network device or a current cell or another network device or another cell in a handover process; sending, by the network device, state information or first change information of a current network device or a current cell or another network device or another cell in a handover process; receiving, by the network device, state information or first change information in a process in which the terminal device executes a handover; sending, by the network device, state information or first change information in a process in which the terminal device executes a handover; receiving, by the network device, state information or first change information before a handover command is sent; sending, by the network device, state information or first change information before a handover command is sent; receiving, by the network device, state information or first change information after a CHO command is sent; or sending, by the network device, state information or first change information after a CHO command is sent.

S620. The network device executes corresponding behavior based on the state information or the first change information.

In a possible implementation, the network device may execute at least one of the following behavior based on the first change information: executing a handover decision, determining whether to resend a handover command, updating a handover command, terminating a handover, or sending a handover command.

In a possible implementation, the terminal device may also execute corresponding behavior based on the state information or the first change information.

In a possible implementation, the network device may send seventh information to the first entity, where the seventh information may be used to indicate whether to execute a handover.

The terminal device may execute at least one of the following behavior based on the seventh information and/or the first change information: executing a handover, skipping executing a handover, terminating a handover, suspending a handover, or suspending partial slice command information.

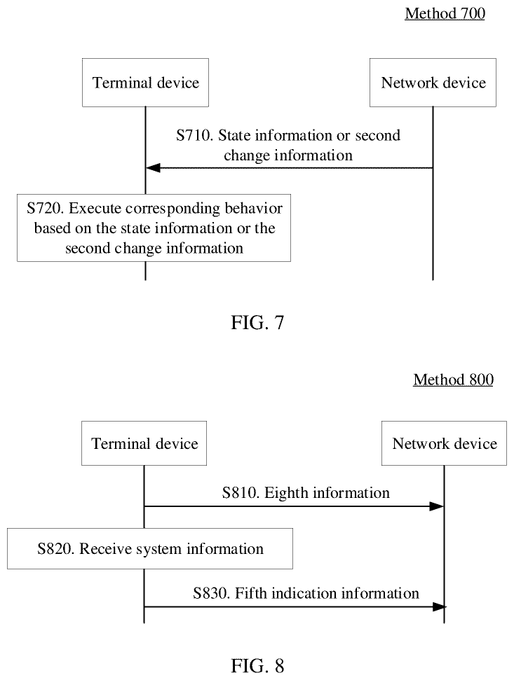

FIG. 7 is a schematic flowchart of a communication method according to an embodiment of this application. The method 700 shown in FIG. 7 may include steps S710 and S720. Details are as follows.

S710. A terminal device sends state information or second change information of a second network device or a second cell, or obtains related information of state information or second change information of a second network device or a second cell.

The state information or the second change information may include at least one of the following:
a network state indication, an on start moment, an off start moment, on duration, off duration, an on end moment, an off end moment, a period of an on state, a quantity of times of maintaining an on state, a period of an off state, a quantity of times of maintaining an off state, a time of a half-on state (for example, at least one of start, end, duration, or a period), a time of a second state (for example, at least one of start, end, duration, or a period), or a time of a third state (for example, at least one of start, end, duration, or a period).

In a possible implementation, the terminal device may obtain the state information or the second change information of the second network device or the second cell and indicated by a network device; or the terminal device may read system information of a current network device/a current cell or the second network device/the second cell, to obtain the state information or the second change information of a current network device/the current cell and/or the second network device/the second cell from the system information.

In a possible implementation, before a handover, or after a handover command is received, or in a handover execution process, or after a CHO command is received, or in a CHO measurement process, or in a case that a CHO handover condition is met, the terminal device may obtain the state information or the second change information of the second network device or the second cell and indicated by a network device; or the terminal device may read system information of a current network device/a current cell or the second network device/the second cell, to obtain the state information or the second change information of a current network device/the current cell and/or the second network device/the second cell from the system information.

S720. The terminal device executes corresponding behavior based on the state information or the second change information.

In a possible implementation, the terminal device may execute at least one of the following based on the state information or the second change information:
determining that the second network device is in an on state or an off state; determining a state of the second network device, and determining that the second cell is in an on state or an off state; determining a state of the second cell, executing a handover, skipping executing a handover, or terminating a handover; suspending a handover or suspending partial slice command information; deleting a configuration of the second cell or reserving a configuration of the second cell; disregarding the second cell or disregarding the second cell in an off state or in a state switching pattern; suspending evaluation of the second cell; suspending a handover to the second cell; suspending evaluation of the second cell or suspending a handover to the second cell in a specific network state; or executing evaluation or a handover in a case that the second cell is in an on state.

In a possible implementation, the second network device may be a network device in which the terminal device is currently located or a network device adjacent to the network device which the terminal device is currently located, and the second cell may be a cell in which the terminal device is currently located or a cell adjacent to the cell in which the terminal device is currently located.

In a possible implementation, the second network device may be a target primary base station or a target base station to be handed over to, and/or the second cell may be a target primary cell or a target primary secondary cell to be handed over to.

In a possible implementation, the terminal device may determine, based on the state information or the second change information, that the second cell is a primary cell PCell, a secondary cell SCell, or a primary secondary cell PSCell; and/or the terminal device may determine, based on the state information or the second change information, that the second network device is a primary base station or a secondary base station.

FIG. 8 is a schematic flowchart of a communication method according to an embodiment of this application. The method 800 shown in FIG. 8 may include steps S810, S820, and S830. Details are as follows.

S810. A terminal device sends eighth information to a network device.

The eighth information may be used to request the network device to send system information.

In a possible implementation, the eighth information may include third indication information, and the third indication information is used to indicate a start moment, an end moment, and/or duration of broadcasting the system information requested by the terminal device.

In a possible implementation, the system information is some or all system information; or the system information is some or all system information supporting an on-demand manner.

S820. The terminal device receives the system information.

In a possible implementation, the terminal device may receive the system information sent by the network device.

In a possible implementation, the system information may include fourth indication information, and the fourth indication information may be used to indicate a start moment, an end moment, and/or duration of broadcasting the system information.

In a possible implementation, the system information is some or all system information; or the system information is some or all system information supporting an on-demand manner.

S830. The terminal device sends fifth indication information to the network device.

The fifth indication information may be used to indicate whether the terminal device needs to prolong broadcast duration of the system information, broadcast duration that needs to be prolonged, and/or whether the system information does not need to be broadcast.

In a possible implementation, the system information is some or all system information; or the system information is some or all system information supporting an on-demand manner.

In a possible implementation, the terminal device may send the fifth indication information to the network device in any one of the following cases:
the broadcast duration of the system information ends, after the fourth indication information is received, the broadcast duration of the system information is exceeded, or the system information is not broadcast.

In this embodiment of this application, a mechanism for stopping broadcasting system information is provided, so that power consumption of broadcasting system information can be reduced.

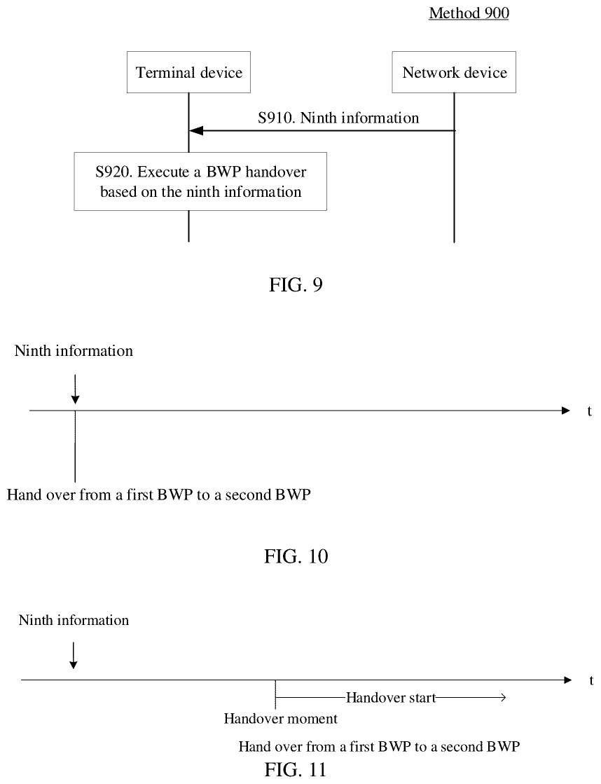

FIG. 9 is a schematic flowchart of a communication method according to an embodiment of this application. The method 900 shown in FIG. 9 may include steps S910 and S920. Details are as follows.

S910. A terminal device receives ninth information sent by a network device.

The ninth information may be used to indicate whether to hand over from a first bandwidth part BWP to a second BWP. In a possible implementation, the second BWP may be at least one of the following: an initial BWP, a BWP of a specific identifier, or a network energy saving BWP. In a possible implementation, a serving cell may configure the network energy saving BWP by using a system message or dedicated information.

In a possible implementation, the second BWP may be configured by a network, or the second BWP is predefined, or may be indicated by ninth information.

In a possible implementation, the ninth information may include at least one of the following: a group identifier, a BWP handover indication, an identifier of the second BWP, an identifier of the first BWP, a handover start moment, handover duration, or a handover end moment.

In a possible implementation, the terminal device may receive the ninth information sent by the network device by using a group radio network temporary identifier (RNTI).

In a possible implementation, the terminal device may receive the ninth information sent by the network device by using DCI, a MAC CE, or RRC.

In a possible implementation, the terminal device may receive, within a common search space, the ninth information sent by the network device.

S920. The terminal device executes a BWP handover based on the ninth information.

In a possible implementation, the terminal device may immediately execute the BWP handover after receiving the ninth information. For example, as shown in FIG. 10, the terminal device is immediately handed over from the first BWP to the second BWP after receiving the ninth information.

In a possible implementation, after receiving the ninth information, the terminal device may execute the BWP handover at a handover moment indicated by the ninth information. For example, as shown in FIG. 11, after receiving the ninth information, the terminal device is handed over from the first BWP to the second BWP at the handover moment indicated by the ninth information.

In a possible implementation, after receiving the ninth information, the terminal device may execute the BWP handover at a moment at which the ninth information is received+a predefined/preconfigured time period.

In this embodiment of this application, the group RNTI is introduced to indicate the terminal device to execute the BWP handover, so that a terminal device in a connected state can be notified in time when the network device determines to save energy, and PDCCH resources can be saved through a group RNTI message.

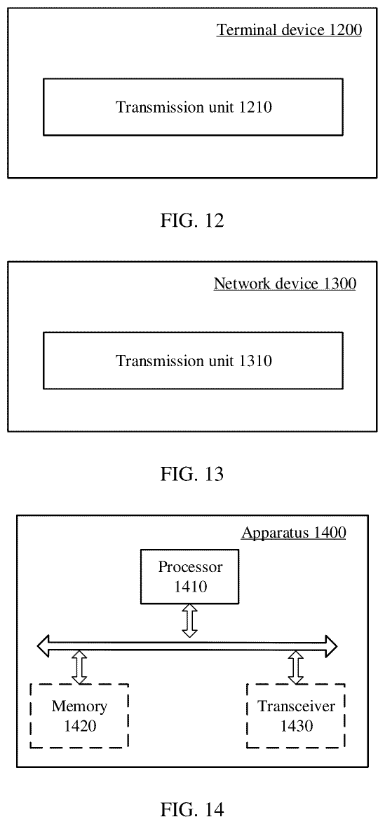

The method embodiments of this application are described in detail above with reference to FIG. 1 to FIG. 11. Apparatus embodiments of this application are described below in detail with reference to FIG. 12 to FIG. 14. It should be understood that the descriptions of the method embodiments correspond to the descriptions of the apparatus embodiments, and therefore, for a part that is not described in detail, reference may be made to the foregoing method embodiments.

FIG. 12 is a schematic structural diagram of a terminal device according to an embodiment of this application. As shown in FIG. 12, the terminal device 1200 includes a transmission unit 1210. Details are as follows.

The transmission unit 1210 is configured to perform communication based on a network state or network state-related information.

The terminal device 1200 may execute the method executed by the terminal device in embodiments of this application.

FIG. 13 is a schematic structural diagram of a network device according to an embodiment of this application. As shown in FIG. 13, the network device 1300 includes a transmission unit 1310. Details are as follows.

The transmission unit 1310 is configured to perform communication based on a network state or network state-related information.

The network device 1300 may execute the method executed by the network device in embodiments of this application.

FIG. 14 is a schematic structural diagram of an apparatus according to an embodiment of this application. Dashed lines in FIG. 14 indicate that the unit or module is optional. The apparatus 1400 may be configured to implement the methods described in the foregoing method embodiments. The apparatus 1400 may be a chip or a communications apparatus (for example, the terminal device 1200 shown in FIG. 12 or the network device 1300 shown in FIG. 13).

The apparatus 1400 may include one or more processors 1410. The processor 1410 may allow the apparatus 1400 to implement the methods described in the foregoing method embodiments. The processor 1410 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1400 may further include one or more memories 1420. The memory 1420 stores a program, where the program may be executed by the processor 1410, to cause the processor 1410 to execute the methods described in the foregoing method embodiments. The memory 1420 may be independent of the processor 1410 or may be integrated into the processor 1410.

The apparatus 1400 may further include a transceiver 1430. The processor 1410 may communicate with another device or chip by using the transceiver 1430. For example, the processor 1410 may send data to and receive data from another device or chip by using the transceiver 1430.

An embodiment of this application further provides a computer-readable storage medium for storing a program. The computer-readable storage medium may be applied to a communications apparatus provided in embodiments of this application, and the program causes a computer to execute a method to be executed by the communications apparatus in embodiments of this application.

An embodiment of this application further provides a computer program product. The computer program product includes a program. The computer program product may be applied to a communications apparatus provided in embodiments of this application, and the program causes a computer to execute a method to be executed by the communications apparatus in embodiments of this application.

An embodiment of this application further provides a computer program. The computer program may be applied to a communications apparatus provided in embodiments of this application, and the computer program causes a computer to execute a method to be executed by the communications apparatus in embodiments of this application.

It should be understood that, in embodiments of this application, “B that is corresponding to A” means that B is associated with A, and B may be determined based on A. However, it should also be understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual needs to achieve the objectives of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising a memory, a transceiver, and a processor, wherein the memory is configured to store a program, the processor performs data receiving and sending by using the transceiver, and the processor is configured to invoke the program in the memory, to cause the terminal device to execute the method comprising:
performing, communication based on a network state or network state-related information.

2. The terminal device according to claim 1, wherein the method further comprises:
determining, the network state, wherein the network state comprises at least one of an on state, an off state, or an on-off switching state that a first network device or a first cell is to be in.

3. The terminal device according to claim 2, wherein the determining, a network state comprises:
obtaining, first configuration information, wherein the first configuration information is used to determine the network state or network state-related information, and/or determine transmission by the terminal device.

4. The terminal device according to claim 3, wherein the first configuration information comprises at least one of the following:
the first configuration information is configured for or indicated to the terminal device in a static or semi-static manner;
the first configuration information is configured for the terminal device; or
the first configuration information is configured for a network device in which the terminal device is currently located or a cell in which the terminal device is currently located.

5. The terminal device according to claim 3, wherein the first configuration information comprises a first parameter, and the first parameter is used to indicate whether a terminal device that does not support network energy saving is capable of accessing the first network device or the first cell, or whether a terminal device that supports network energy saving is capable of accessing the first network device or the first cell;
wherein the method further comprises:
determining, based on the first parameter, whether to access the first network device or the first cell.

6. The terminal device according to claim 3, wherein the first configuration information comprises at least one of the following: a network state indication or an entered network state, an on-off switching state indication, a period of the on-off switching state, a pattern of the on-off switching state, an on indication or an on state indication, an off indication or an off state indication, a time of the on state, or a time of the off state;
wherein the period of the on-off switching state comprises at least one of the following: an on period, an off period, on duration, off duration, an on start moment, an off start moment, an on end moment, an off end moment, a switching period of the on-off switching state, an on-off switching period of the on-off switching state, or a period of the pattern of the on-off switching state;
the pattern of the on-off switching state comprises at least one of the following: a start moment of the pattern, an end moment of the pattern, an on location in the pattern, or an off location in the pattern;
the time of the on state comprises at least one of the following: an on period, on duration, an on start moment, or an on end moment;
the time of the off state comprises at least one of the following: an off period, off duration, an off start moment, or an off end moment.

7. The terminal device according to claim 3, wherein the first configuration information indicates transmission information for transmitting the first indication information, or indicates configuration information for transmitting the first indication information, wherein the first indication information is used by the terminal device to monitor whether the first network device or the first cell enters the on state, the off state, or the on-off switching state, or is used to indicate the network state that the first network device or the first cell enters to the terminal device, or is used to indicate that the first network device or the first cell enters the on state, the off state or the on-off switching state to the terminal device.

8. The terminal device according to claim 3, wherein the first configuration information comprises a first monitoring location and/or a first monitoring configuration, wherein the first monitoring location and/or the first monitoring configuration, are/is used to configure the terminal device to perform monitoring, or are/is used by the terminal device to determine that the first network device or the first cell enters the on state, the off state, or the on-off switching state, or are/is used by the terminal device to send or receive the first indication information.

9. The terminal device according to claim 8, wherein the first monitoring location, and/or the first monitoring configuration meet/meets the following:
being within a preset time domain interval.

10. The terminal device according to claim 7, wherein the first indication information comprises at least one of the following: a switching indication or information, an on indication or information, or an off indication or information.

11. The terminal device according to claim 7, wherein the method further comprises:
sending or receiving, at least one of the following information: a synchronization signal block SSB, a reference signal RS, a physical downlink control channel PDCCH, a physical uplink control channel PUCCH, downlink data, uplink data, a random access channel RACH, or a scheduling request SR after state switching, or after the first cell or the first network device is in the on state.

12. The terminal device according to claim 3, wherein the first configuration information comprises a transmission configuration of third information.

13. The terminal device according to claim 12, wherein the third information is at least one of the following:
a synchronization signal block SSB, system information, a reference signal RS, a physical downlink control channel PDCCH, a physical uplink control channel PUCCH, downlink data, uplink data, a random access channel RACH, semi-persistent scheduling SPS, a configured grant CG, or a scheduling request SR.

14. The terminal device according to claim 12, wherein the performing, communication based on a network state or network state-related information comprises:
sending or receiving, the third information within the on state or within an on state in the on-off switching state; and
skipping sending or skipping receiving, the third information within the off state or an off state in the on-off switching state.

15. The terminal device according to claim 1, wherein the network state-related information comprises at least one of the following:
the network state, duration of the on state, duration of the off state, a start moment of the on state, a start moment of the off state, an end moment of the on state, an end moment of the off state, a period of the on state, or a period of the off state.

16. The terminal device according to claim 1, wherein the method further comprises:
obtaining, state information or first change information of a second network device or a second cell from a network device, wherein the state information or the first change information comprises at least one of the following:
a network state indication, an on start moment, an off start moment, on duration, off duration, an on end moment, an off end moment, a period of an on state, or a period of an off state.

17. The terminal device claim 16, wherein the method further comprises:
receiving, seventh information sent by the network device, wherein the seventh information is used to indicate whether to execute a handover.

18. The terminal device according to claim 17, wherein the method further comprises:
executing, the following behavior based on the seventh information and/or the first change information: executing a handover.

19. A network device, comprising a memory, a transceiver, and a processor, wherein the memory is configured to store a program, the processor performs data receiving and sending by using the transceiver, and the processor is configured to invoke the program in the memory, to cause the network device to execute the method comprising:
performing, communication based on a network state or network state-related information.

20. A communication method, comprising:
performing, by a terminal device, communication based on a network state or network state-related information.
